(19) United States
(12) Patent Application Publication
(10) Pub. No.: US 2004/0002851 A1
(43) Pub. Date: Jan. 1, 2004

(54) System and method of automatic personalization of computer users' computing experience

(76) Inventor: Steven J. Simske, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/185,384

(22) Filed: Jun. 28, 2002

(51) Int. Cl. G06F 17/27

(52) U.S. Cl. 704/9

(57) ABSTRACT

A system of automatically personalizing a user's computing experience and a method for performing the same. The method comprises the steps of automatically collecting data from a user's computing device, automatically analyzing the collected data and generating a select set of data, generating personalized information based on the select set of data, and presenting the personalized information to the user.

### TECHNICAL FIELD OF THE INVENTION

The present invention relates generally to the field of computers and computer software, and more particularly to a system and method of automatic personalization of computer users' computing experience.

### BACKGROUND OF THE INVENTION

Every white collar worker today uses a computer for at least a part of their workday. Most professionals spend the majority of their workday in front of a computer screen. Computer ownership and usage is also rising steadily in our schools and homes. Computer users use computers to draft and prepare documents, send and receive email messages, generate and analyze data, receive news, financial, sports and weather reports, surf the Word Wide Web for business as well as personal research, and so on. Some of the computer user's computing experience is tailored to some extent to personal needs and tastes, such as web portals that allow their users to configure the type and format of the data displayed as the user views the web page. Some online subscription services push data of the type and format requested and configured by a user during an initial setup session, for example stock prices of certain publicly-held corporations selected by the user, the current weather report of a locale selected by the user, or the horoscope of the user. However, the extent that such services can be personalized is somewhat limited by the built-in configurable parameters. For example, a user can typically enter in personal birth date and year to receive daily horoscope email messages or select the type of financial data to view, but cannot personalize the interface or session experience in any other way.

### SUMMARY OF THE INVENTION

In accordance with an embodiment of the present invention, a method of automatically personalizing a user's computing experience comprises automatically collecting data from a user's computing device, automatically analyzing the collected data and generating a select set of data, generating personalized information based on the select set of data, and presenting the personalized information to the user.

In accordance with another embodiment of the invention, a method of automatically personalizing a user's computing experience comprises automatically collecting text from a user's computing device, analyzing the collected text and generating a select set of keywords therefrom, generating personalized information based on the select set of keywords, and presenting the personalized information to the user

In accordance with yet another embodiment of the present invention, a system of automatically personalizing a user's computing experience comprises means for automatically collecting data from a user's computing device, means for automatically analyzing the collected data and generating a select set of data, means for generating personalized information based on the select set of data; and means for presenting the personalized information to the user.

In accordance with a further embodiment of the present invention, a system of automatically personalizing a user's computing environment comprises a collector operable to receive data encountered in the user's computing environment, a processor operable to select a set of data from the data received by the collector, a personalized information generator operable to generate personalized information from the set of selected data, and a data presenter delivering the personalized information to the user.

In accordance with yet another embodiment of the present invention, a system comprises a computer-readable medium having encoded thereon a process operable to collect data encountered by a user from the user's computing device, analyze the collected data and generate a select set of keywords therefrom, generate personalized information based on the select set of keywords, and automatically present the personalized information to the user.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a simplified block diagram of an exemplary computing environment of a computer user;

FIG. 2 is a functional block diagram of an embodiment of a system of automatic personalization of computer user's computing experience according to the teachings of the present invention; and

FIG. 3 is a flowchart of an embodiment of a method of automatic personalization of computer user's computing experience according to the teachings of the present invention.

### DETAILED DESCRIPTION OF THE DRAWINGS

The preferred embodiment of the present invention and its advantages are best understood by referring to FIGS. 1 through 3 of the drawings, like numerals being used for like and corresponding parts of the various drawings.

FIG. 1 is a simplified block diagram of a typical computing environment of a typical computer user. Computer users use computing devices 12 ranging from personal digital assistants to laptops to workstations to perform a variety of tasks. These tasks may include local tasks such as drafting text documents, preparing drawings and diagrams, and generating and analyzing data, that are stored locally in co-located database(s) or data storage device(s) 14. These tasks may also include online tasks such as accessing and viewing data or web pages from remote servers 16 stored in remote database(s) or data storage device(s) 18 over a computer network 20 such as the Internet. The software code associated with some embodiments of automatic personalization of a computer user's computing environment may execute at the user's computing device 12, at a remote server 16, or a combination of both.

Because interfacing and using computing devices occupy such a large portion of many people's daily business and personal lives, it is desirable to make that experience as pleasant as possible. System and method of automatic personalization of computer users' computing experience is a solution that enables computers to provide a highly-personalized and therefore more pleasant environment to the users.

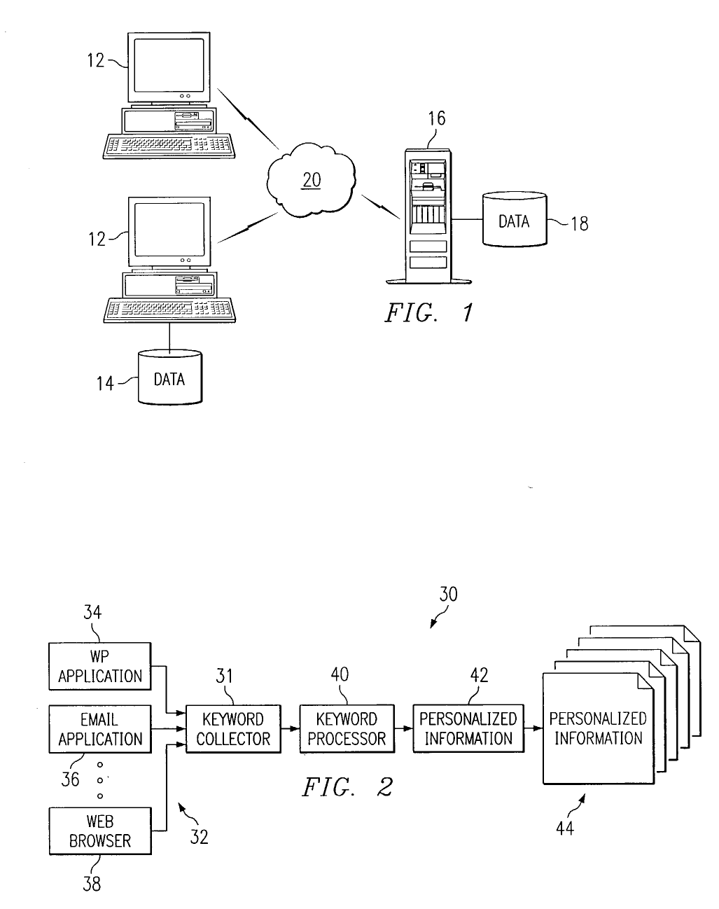

FIG. 2 is a functional block diagram of an embodiment of a system 30 of automatic personalization of computer user's computing experience according to the teachings of the present invention. A collector such as a keyword collector 31 of system 30 collects data such as keywords and phrases from application programs 32 in use by the computer user. For example, keyword collector 31 may collect keywords and phrases from text documents drafted or viewed by the user using a word processing application 34, email messages prepared and received by the user using an email client 36, and web pages and documents pulled and viewed by the user using a web browser 38. Collector 31 polls the appropriate application software (word processing, email, browser, etc.) or hardware (keyboard) to collect the appropriate data. In other embodiments, the collector may collect graphical, audio, video and other rich media data that are encountered by the user in his/her daily computing experience. The metadata used to describe the content and other properties of the rich media may be collected by the collector as well to extract keywords and phrases.

In an alternative embodiment, collector 31 is operable to receive data pushed to it by other applications and/or hardware. In this embodiment, the presence, location and/or interface protocol of collector 31 is known and publicized to other applications and hardware to enable the communication of data therebetween. The user is capable of enabling or initiating this push feature on-the-fly using a user interface.

A processor such as a keyword processor 40 receives the collected data from keyword collector 31 and attempts to select those words and phrases that are likely to be most meaningful to the user by some discriminating criteria. Keyword processor 40 may analyze the words and phrases based on parts of speech (POS) analysis and by further weighting selected words using a predetermined algorithm. For example, keyword processor 40 may tag each word as common noun, proper noun, pronoun, verb, adverb, adjective, etc. Depending on the type of desired output, certain parts of speech may be favored over others. For example, if the user desires personalized word-scrambling puzzles, common nouns may be preferred over proper nouns. The weighting function may be performed by assigning more weight or importance to words that appear more frequently than others, for example. Other more sophisticated methods now known or later developed may also be used to analyze the keywords to generate a select set of keywords. Based on the parts of speech analysis and the weighting assignment, a certain number of keywords may be collected from the previous day's web pages, email messages and documents. As an illustrative example, the collected keywords may be organized and stored in a data structure and expressed in XML (eXtensible Markup Language) as the following:

<Keywords>

<Number of Keywords>10 </Number of Keywords>
<Word>marketing</Word>
<Word>checklist</Word>
<Word>forecast</Word>
<Word>press release</Word>
<Word>China</Word>
<Word>Asia</Word>
<Word>timing</Word>
<Word>Hong Kong</Word>
<Word>Taiwan</Word>
<Word>patents</Word>

</Keywords>

The collection of keywords may also include other specific information, such as the source of each keyword, the weight assigned to each keyword, and the parts of speech assignment of each keyword, etc. For example, the weighting may be added to expression as follows:

<Keywords>

<Number of Keywords>10</Number of Keywords>
<Word weight=“0.20”>marketing</Word>
<Word weight=“0.17”>patent</Word>
<Word weight=“0.13”>forecast</Word>
<Word weight=“0.12”>press release</Word>
<Word weight=“0.09”>China</Word>
<Word weight=“0.08”>Asia</Word>
<Word wieght=“0.08”>timing</Word>
<Word weight=“0.06”>Hong Kong</Word>
<Word weight=“0.04”>Taiwan</Word>
<Word weight=“0.03”>checklist</Word>

</Keywords>

Keyword collector 31 may also be a collector that is operable to collect rich media data and their associated metadata. The collector then is operable to handle rich media file types and data formats. Keyword processor 40 may then analyze the rich media and the associated metadata to similarly evaluate the data based on some criteria. The analysis may be based on the content of the rich media itself or the metadata associated therewith.

A personalized information generator 42 in communication with keyword processor 40 receives or accesses the collected and analyzed keywords and uses the keywords to produce personalized information 44, such as personalized games and messages, that adds a personal touch to the user's computing experience. The personalized games and messages are delivered and presented to the user by a data presenter (not explicitly shown) in a predetermined manner and following predetermined timing set by the user. In a preferred embodiment, the data presenter is primarily a display screen on the user's computer. For example, the user may elect to receive personalized word games and messages via email, in a pop-up window that is displayed on the user's screen, or any other suitable method. The user may configure the application to receive the personalized messages every morning at 8:00 A.M or every three hours between the window of 8:00 A.M. and 5:00 P.M. More details of personalized game and message generation are presented below.

Although the description herein is primarily concerned with collecting a particular type of data encountered by the user in his/her computing environment such as text, other forms of data may also be collected, analyzed and used to personalize the user's computing experience. For example, audio signals, graphics, animation, photographs, and other data elements may be collected from web pages, web sites, documents, and other user experiences. The metadata and other data describing the properties of the data may also be collected and processed to generate the personalized information. In addition to games and messages primarily involving words, pictorial games and messages may be generated by personalized information generator 42. For example, the moveable tiles of a popular game may bear a selected photograph, where the user can move the tiles in a two-dimensional manner to reconstitute the photograph. The photograph may also be used as the basis for a puzzle. Other games and amusements now known and later developed can be generated from the collected data of the present invention.

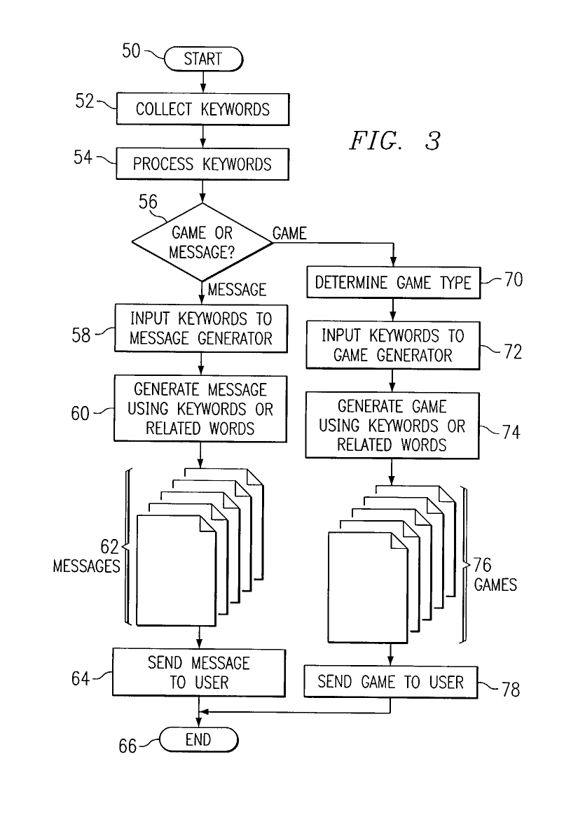

FIG. 3 is a flowchart of an embodiment of a method 50 of automatic personalization of computer user's computing experience according to the teachings of the present invention. Referring also to FIG. 2, keywords and phrases are collected by keyword collector 31, as shown in block 52. The collected keywords and phrases are then processed to narrow down the set of collected words and phrases to those that seem to be the most meaningful or important to the user, as shown in block 54. In block 56, a determination is made as to whether the user has selected to personalize his/her computing environment with personalized messages or games. Alternatively, the user may also elect to have the option to receive and select various different types of personalized information. It should be noted that word games and text messages are merely two examples of personalized information that can be generated from the collected keywords and phrases and that other types of personalized information generation and delivery are contemplated by the teachings of the present invention.

If the user had selected receiving personalized messages, then the keywords are provided as input to personal information generator 42, as shown in block 58. Personal information generator 42 then generates personalized message 62 using the collected keywords and phrases and perhaps other words and phrases that are commonly associated with the collected keywords and phrases, as shown in block 60. For example, if a keyword is “marketing,” perhaps related words such as “sales,” “promotion,” “roll-out,” etc. may be used to generate the personalized information. If the keyword is “patent” then a message related to intellectual property rights may be appropriate. The personalized message may be inspirational, humorous, insightful, a famous quotation or poem, a relevant news story, a fortune message, or a horoscope. Natural language processing (NLP) techniques may be used to enhance the quality of the generated message and allow the messages to be context-sensitive. For example, keying off the keywords “marketing,” “China” and “timing” and context-sensitive information, a message such as the following may be generated: “Your efforts to market and introduce new product in China will be successful with the right timing.” If news is selected as preferred by the user, personalized information generator 42 may search the Internet, World Wide Web or another computer network (such as company intranet) for news stories or current events that include the important keywords and phrases. Advertizers may also use this feature to supply news on products, services, pricing, etc. A database of famous quotations, jokes, insightful messages, etc. may be searched for keywords and synonyms to generate the personal message. The message is then delivered to the user in a manner configured by the user, as shown in block 64. The timing and format of the delivery can be preset by the user. If desired, the delivery or presentation of the personalized message can be accompanied, if desired, by music that is appropriately matched to the generated message. The process ends in block 66.

If in block 56 it is determined that the user had selected personalized games, then a determination is further made as to the type of game preferred by the user, as shown in block 70. Alternatively, the user may elect to receive a variety of games generated and delivered at random. The collected and weighted keywords and phrases are provided as input to personal information generator 42 to generate a game, as shown in blocks 72 and 74. The collected keywords can be used as the basis to generate a large variety of word-based games 76; for example, scrambled-word puzzles, word search puzzles, crossword puzzles, etc. may be generated. Although specific examples of certain word-based games are described below, the generation and delivery of other games are also contemplated by the teachings of the present invention.

To generate a scrambled-word puzzle, the collected keywords and, in some embodiments, possibly related words and synonyms are scrambled:

| | |
|---|---|
| R E M A K T | = |
| T T E P N A | = |
| H I A N C | = |
| W T I A A N | = |

where the answers are “MARKET,” “PATENT,” “CHINA,” and “TAIWAN”, respectively.

To generate a word search puzzle, the collected keywords and possibly related words and synonyms are automatically arranged in a compact matrix in various directions:

```
T M
    A N I H C A
    R I S
    K W I
    E P A T E N T
    T N
    I
  G N I M I T
    G
```

Next, the blank spaces are filled in with randomly-generated letters:

T M R G F Q P L U
R A N I H C A A B
E R I J M S S K I
N K W C I X J O H
K E R P A T E N T
V T S P T N U N G
W I I N E A D F S
G N I M I T Z K R
E G W I P B U K S

Instead of filling the blanks with random letters, personalized information generator 42 may insert a relevant inspirational, insightful or funny phrase or sentence in the blanks as an added element for the user to search and find. A sentence directly extracted out of a document prepared or viewed by the user on a previous day may also be woven into the puzzle in the same manner.

Other word-based puzzles may be generated using the collected keywords and phrases. For example, crossword puzzles may be generated in a manner similar to the word search puzzles. The generated game is then presented to the user in some predetermined manner, such as delivered as an email message, as an attachment to an email message, as a pop-up window, etc., as shown in block 78. The process ends in block 66.

It may be seen that process 50 may be extended to the collection of non-text data from the user's screen, such as graphical elements, photographs, and other data that may also be used as the basis for creating a personalized computing environment. Such graphical elements, for example, may be superimposed over the user's screen or presented in some other manner after some predetermined processing. For example, the graphical element or photograph may be morphed or changed in some other manner prior to presentation to the user.

Currently, games or other applications enable the user to provide limited information to customize the computing environment. For example, the user may provide his/her name, age, sex, occupation, and preferences in the type of data to be delivered in order to personalize a web portal welcome screen. In these applications the user has to deliberately enter information in order to initiate the customization aspect of the application. Many users simply prefer not to spend the time to input the personal and preference data. However, the system and method of the present invention automatically gathers information to personalize the user's computing experience. As a result, the user will receive daily or throughout-the-day messages and/or games that are tailored and customized based on data the user has encountered previously. This creates a personalized computing environment for the user that makes the experience more pleasant. In response to privacy concerns, the user may turn off the keyword or data collection function on-the-fly. Alternatively, process 50 may automatically cease keyword collection in special predetermined circumstances, such as when the user is viewing or entering data on a secured web site.

What is claimed is:

1. A method, comprising:
automatically collecting data from a user's computing device;
analyzing the collected data and generating a select set of data;
generating personalized information based on the select set of data; and
presenting the personalized information to the user.

2. The method, as set forth in claim 1, wherein automatically collecting data comprises automatically collecting text entered by the user.

3. The method, as set forth in claim 1, wherein automatically collecting data comprises automatically collecting text displayed on the user's computing device.

4. The method, as set forth in claim 1, wherein automatically collecting data comprises automatically collecting text processed by an application program executing on the computing device.

5. The method, as set forth in claim 1, wherein automatically collecting data comprises automatically collecting data selected from the group consisting of text, audio, video, multimedia, graphical, and pictorial.

6. The method, as set forth in claim 1, wherein automatically collecting data comprises enabling and disabling data collection in response to receiving user input.

7. The method, as set forth in claim 1, wherein analyzing collected data comprises automatically assigning a weighting value to individual units of the collected data according to predetermined criteria.

8. The method, as set forth in claim 1, wherein analyzing collected data comprises automatically assigning a weighting value to individual units of the collected data according to the frequency of occurrence of the individual units of the collected data.

9. The method, as set forth in claim 1, wherein analyzing collected data comprises:
identifying the parts of speech of each of the collected text;
selecting a set of collected text as keywords being a certain parts of speech;
automatically assigning importance to the keywords according to predetermined criteria; and
generating a set of keywords having highest importance.

10. The method, as set forth in claim 1, wherein generating personalized information comprises building a personalized text message using the select set of data.

11. The method, as set forth in claim 1, wherein generating personalized information comprises building a text message using the select set of data and data relevant to the select set of data.

12. The method, as set forth in claim 1, wherein generating personalized information comprises building a word-based game using the select set of data.

13. The method, as set forth in claim 1, wherein generating personalized information comprises building a word-based game using the select set of data and data relevant to the select set of data.

14. The method, as set forth in claim 1, wherein generating personalized information comprises building the personalized information using data relevant to the select set of data from a global network.

15. The method, as set forth in claim 1, wherein generating personalized information comprises building at least one specific type of personalized information in response to user input.

16. The method, as set forth in claim 1, wherein presenting the personalized information comprises displaying the generated personalized information on a screen of the computing device.

17. The method, as set forth in claim 1, wherein presenting the personalized information comprises sending the generated personalized information to the user in an email message.

18. The method, as set forth in claim 1, wherein presenting the personalized information comprises sending the generated personalized information to the user in at least one manner specified by the user.

19. The method, as set forth in claim 1, wherein presenting the personalized information comprises sending the generated personalized information to the user at at least one time-of-day specified by the user.

20. The method, as set forth in claim 1, wherein presenting the personalized information comprises sending the generated personalized information to the user at at least one random time-of-day as specified by the user.

21. A method of automatically personalizing a user's computing experience, comprising:
collecting data encountered by a user from the user's computing device;
analyzing the collected data and generating a select set of keywords therefrom;
generating personalized information based on the select set of keywords; and
automatically presenting the personalized information to the user.

22. The method, as set forth in claim 21, wherein collecting data comprises automatically collecting text entered by the user.

23. The method, as set forth in claim 15, wherein collecting data comprises automatically collecting text displayed on the user's computing device.

24. The method, as set forth in claim 21, wherein collecting data comprises automatically collecting text processed by an application program executing on the computing device.

25. The method, as set forth in claim 21, wherein collecting data comprises automatically collecting data selected from the group consisting of text, audio, video, multimedia, graphical, and pictorial.

26. The method, as set forth in claim 21, wherein collecting data comprises enabling and disabling data collecting in response to user input.

27. The method, as set forth in claim 21, wherein analyzing collected data comprises automatically assigning a weighting value to each of the collected text according to predetermined criteria.

28. The method, as set forth in claim 21, wherein analyzing collected data comprises automatically assigning a weighting value to each of the collected data according to the frequency of occurrence of the collected data.

29. The method, as set forth in claim 21, wherein analyzing collected data comprises:
identifying the parts of speech of each text in the collected data;
selecting a set of collected text as keywords being a certain parts of speech;
automatically assigning importance to the keywords according to predetermined criteria; and
generating a set of keywords having highest importance.

30. The method, as set forth in claim 21, wherein generating personalized information comprises building a personalized text message using the select set of keywords.

31. The method, as set forth in claim 21, wherein generating personalized information comprises building a text message using the select set of keywords and data relevant to the select set of keywords.

32. The method, as set forth in claim 21, wherein generating personalized information comprises building a word-based game using the select set of keywords.

33. The method, as set forth in claim 21, wherein generating personalized information comprises building a word-based game using the select set of keywords and data relevant to the select set of keywords.

34. The method, as set forth in claim 21, wherein generating personalized information comprises building personalized information using data relevant to the select set of keywords from a computer network.

35. The method, as set forth in claim 21, wherein generating personalized information comprises building at least one type of personalized information in response to user input.

36. The method, as set forth in claim 21, wherein presenting the personalized information comprises displaying the generated personalized information on a screen of the computing device.

37. The method, as set forth in claim 21, wherein presenting the personalized information comprises sending the generated personalized information to the user in an email message.

38. The method, as set forth in claim 21, wherein presenting the personalized information comprises sending the generated personalized information to the user in a manner and time-of-day specified by the user.

39. A system of automatically personalizing a user's computing experience, comprising:
means for collecting data from a user's computing device;
means for analyzing the collected data and generating a select set of data;
means for generating personalized information based on the select set of data; and
means for presenting the personalized information to the user.

40. The system, as set forth in claim 39, wherein means for collecting data comprises means for automatically collecting data selected from the group of text, audio, video, multimedia, graphical and pictorial data encountered or entered by the user.

41. The system, as set forth in claim 39, wherein means for analyzing collected data comprises means for automatically assigning a weighting value to individual units of the collected data according to predetermined criteria.

42. The system, as set forth in claim 39, wherein means for analyzing collected data comprises:
means for identifying the parts of speech of each of the collected text;
means for selecting a set of collected text as keywords being a certain parts of speech;
means for automatically assigning importance to the keywords according to predetermined criteria; and
means for generating a set of keywords having highest importance.

43. A system of automatically personalizing a user's computing environment, comprising:
a collector operable to collect data encountered in the user's computing environment;
a processor operable to select a set of data from the data collected by the collector;
a personalized information generator operable to generate personalized information from the set of selected data; and
a data presenter operable to deliver the personalized information to the user.

44. The system, as set forth in claim 43, wherein the collector comprises a keyword collector operable to receive text encountered in the user's computing environment.

45. The system, as set forth in claim 43, wherein the processor comprises a keyword processor operable to select a set of keywords from the data received by the collector by using a predetermined set of selection criteria.

46. The system, as set forth in claim 43, wherein the personalized information generator is operable to generate personalized messages from the set of selected data.

47. The system, as set forth in claim 43, wherein the personalized information generator is operable to generate personalized word-based games from the set of selected data.

48. The system, as set forth in claim 43, wherein the data presenter comprises a display monitor operable to display the generated personalized information to the user.

49. A system comprising:
a computer-readable medium having encoded thereon a process operable to:
collect data encountered by a user from the user's computing device;
analyze the collected data and generate a select set of keywords therefrom;
generate personalized information based on the select set of keywords; and
automatically present the personalized information to the user.
